(19) United States
(12) Patent Application Publication
(10) Pub. No.: US 2026/0163770 A1
(43) Pub. Date: Jun. 11, 2026

(54) LINEAR PHASE FILTERING IN HIGH-LEVEL MODULATION DIGITAL COMMUNICATIONS

(71) Applicant: John Howard, Upper Mount Bethel, PA (US)

(72) Inventors: John Howard, Upper Mount Bethel, PA (US); Steve Jalil, Boonton, NJ (US); Rana Barsbai, Boonton, NJ (US)

(73) Assignee: John Howard, Upper Mount Bethel, PA (US)

(21) Appl. No.: 19/337,978

(22) Filed: Sep. 24, 2025

Related U.S. Application Data
(60) Provisional application No. 63/705,085, filed on Oct. 9, 2024.

(51) Int. Cl. H04L 25/49

(52) U.S. Cl. CPC H04L 25/4917

(57) ABSTRACT

A method of extending phase linearity associated with a filtering device used with a multilevel digital signal includes configuring a linearized phase filter in accordance with equation (1) as follows

$$H ( s ) = \frac{{\sum }_{n = 1}^{N} {A}_{n} {P}_{n} ( s )}{{\sum }_{m = 1}^{M} {B}_{m} {Q}_{m} ( s )} , \qquad ( 1 )$$

wherein n=1, . . . N, m=1, . . . M, N and M represent maximum terms of the polynomial, N is not equal to M, s=j*ω, ω=2πf, Pₙ and Qₘ represent polynomials, and f represent a normalized frequency of operation. The configuring includes a synthesis-by-analysis method and an iterative process. The method may decrease at least one of rise times and fall times associated with the multilevel digital signal, and decrease ringing associated with the multilevel digital signal. A linearized phase filter configured to be used with a multilevel digital signal includes a filtering device configured in accordance with equation (1).

### CROSS-REFERENCE TO RELATED APPLICATION

This application claims the benefit of and priority to U.S. Provisional Application No. 63/705,085, filed Oct. 9, 2024, the disclosure of which is incorporated herein by reference in its entirety.

### BACKGROUND

The disclosed embodiments generally relate to multilevel digital signal processing, and more particularly to extending phase linearity using multilevel digital signal filtering.

### SUMMARY

In some aspects, a method of extending phase linearity associated with a filtering device used with a multilevel digital signal includes configuring a linearized phase filter in accordance with equation (1) as follows

$$H ( s ) = \frac{{\sum }_{n = 1}^{N} {A}_{n} {P}_{n} ( s )}{{\sum }_{m = 1}^{M} {B}_{m} {Q}_{m} ( s )} , \qquad ( 1 )$$

wherein n=1, . . . N, m=1, . . . M, N and M represent maximum terms of the polynomial, N is not equal to M, s=j*ω, ω=2πf, and f represent a normalized frequency of operation. The configuring includes a synthesis-by-analysis method and an iterative process.

The method may decrease at least one of rise times and fall times associated with the multilevel digital signal, and decrease ringing associated with the multilevel digital signal.

In other aspects, a linearized phase filter configured to be used with a multilevel digital signal includes a filtering device configured in accordance with equation (1) as follows

$$H ( s ) = \frac{{\sum }_{n = 1}^{N} {A}_{n} {P}_{n} ( s )}{{\sum }_{m = 1}^{M} {B}_{m} {Q}_{m} ( s )} , \qquad ( 1 )$$

wherein n=1, . . . N, m=1, . . . M, N and M represent maximum terms of the polynomial, N is not equal to M, s=j*ω, ω=2πf, and f represent a normalized frequency of operation. The configuration includes a synthesis-by-analysis method and an iterative process.

The linearized phase filter may decrease at least one of rise times and fall times associated with the multilevel digital signal, and decrease ringing associated with the multilevel digital signal.

Aspects of the disclosed embodiments will become apparent upon consideration of the disclosed preferred embodiments, particularly when taken in conjunction with the accompanying drawings, wherein like reference numerals in the various figures are utilized to designate like components.

### BRIEF DESCRIPTION OF THE DRAWINGS

The following drawings are provided by way of example only and without limitation, wherein like reference numerals (when used) indicate corresponding elements throughout the several views, and wherein:

FIG. 1 depicts a graph of phase deviation relative to linear phase as a function of angular frequency ω for various types of filter designs; and

FIG. 2 depicts a graph of amplitude as a function of angular frequency ω for various types of filter designs.

It is to be appreciated that elements in the figures are illustrated for simplicity and clarity. Common but well-understood elements that are useful or necessary in a commercially feasible embodiment are not shown in order to facilitate a less hindered view of the illustrated embodiments.

### DETAILED DESCRIPTION

The disclosed embodiments are directed to a rational polynomial method that is utilized to extend the linear phase of filters, thereby substantially enhancing the performance of multilevel digital signals. These embodiments permit an increase in the accuracy and resolution of multilevel digital signals by maintaining the sharpness, such as by decreasing rise times and/or fall times, associated with transitions between multiple levels in the time domain and by avoiding amplitude variations, such as ringing, associated with these transitions.

There is a substantial need for maintaining the integrity of a large quantity of levels in a digital symbol with respect to high-index digital modulation. For example, with respect to modulations, which includes but is not limited to 256 QAM, 1024 QAM, and 4096 QAM, linear phase filtering is critical. To achieve level integrity, various filter designs may be utilized that exhibit varying degrees of phase linearity. Alternatively, external phase linearization may be implemented to achieve greater linearity. Non-phase linearity in multilevel digital symbols causes amplitude variations, such as ringing, which substantially reduce the accuracy and resolution of the various levels in multilevel digital signals.

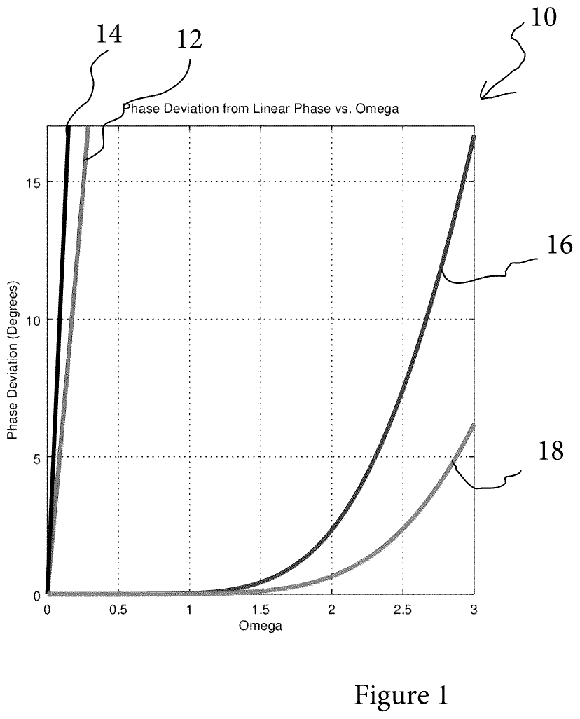

FIG. 1 shows a graph 10 of the deviation in phase relative to a linear phase as a function of angular frequency ω with respect to various filter designs. Specifically, FIG. 1 illustrates a relative linearity of different types of filter designs, which include Butterworth filter 12, Chebyshev filter 14, maximally flat phase filter 16, which represents the theoretical flat phase filter, and linearized phase filter 18 designs. The linearized phase filter 18 design is configured in accordance with one or more embodiment disclosed herein.

A substantial decrease in phase deviation is provided as a result of utilizing the linearized phase filter 18 design configured in accordance with one or more embodiments disclosed herein, when compared with the Butterworth filter 12, Chebyshev filter 14, and maximally flat phase filter 16 designs. Specifically, the phase deviation associated with the plot representing the linearized phase filter 18 design remains substantially flat or zero over a substantially greater bandwidth than the phase deviation associated with the plots representing the Butterworth filter 12, Chebyshev filter 14 and maximally flat phase filter 16 designs as the angular frequency ω increases.

The linearized phase filter is implemented in accordance with a polynomial expression shown in equation (1) below and further discussed in Markushevich, et al., Theory of Functions of a Complex Variable, Chelsea Pub., Chapter 1.18, 1997.

$$H ( s ) = \frac{{\sum }_{n = 1}^{N} {A}_{n} {P}_{n} ( s )}{{\sum }_{m = 1}^{M} {B}_{m} {Q}_{m} ( s )} , \qquad ( 1 )$$

where n=1, . . . N, m=1, . . . M, N and M are maximum terms of the polynomial, N is not equal to M, s=j*ω, ω=2πf, and f represents a normalized frequency of operation. By utilizing a synthesis-by-analysis method and introducing an iterative process, as disclosed in Demidovich et al., Computational Mathematics, Mir Publishers, Chapters 8 and 16, Moscow, 1981, the polynomial coefficients Aₙ and Bₘ may be computed. Pₙ and Qₘ represent polynomials that may be computed in accordance with the aforementioned reference (Demidovich et al., Computational Mathematics, Mir Publishers, Chapters 8 and 16, Moscow, 1981).

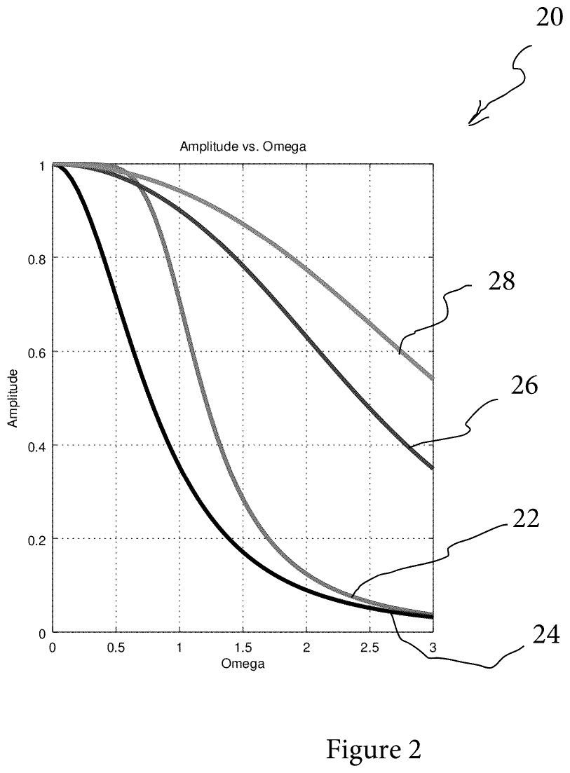

FIG. 2 shows a graph 20 of amplitude as a function of angular frequency ω based on Butterworth filter 22, Chebyshev filter 24, maximally flat phase filter 26, and linearized phase filter 28 designs. A substantial increase in amplitude and bandwidth is provided as a result of utilizing the linearized phase filter 28 design configured in accordance with one or more embodiments disclosed herein, when compared with the Butterworth filter 22, Chebyshev filter 24, and maximally flat phase filter 26 designs. Specifically, the amplitude associated with the plot representing the linearized phase filter 28 design remains substantially greater than the amplitude associated with the plots representing the Butterworth filter 22, Chebyshev filter 24, and maximally flat phase filter 26 designs as the angular frequency ω increases.

The illustrations of embodiments herein are intended to provide a general understanding of the structure of various embodiments, and the embodiments are not intended to serve as a complete description of all the elements and features of apparatus and systems that may make use of the structures described herein. Many other embodiments will be apparent to those skilled in the art upon reviewing the above description. Other embodiments are utilized and derived therefrom, such that structural and logical substitutions and changes are made without departing from the scope of this disclosure. Figures are also merely representational and are not drawn to scale. Certain proportions thereof are exaggerated, while others are decreased. Accordingly, the specification and drawings are to be regarded in an illustrative rather than a restrictive sense.

Such embodiments are referred to herein, individually and/or collectively, by the term “embodiment” merely for convenience and without intending to voluntarily limit the scope of this application to any single embodiment or inventive concept if more than one is in fact shown. Thus, although specific embodiments have been illustrated and described herein, it should be appreciated that any arrangement calculated to achieve the same purpose may be substituted for the specific embodiments shown. This disclosure is intended to cover any and all adaptations or variations of various embodiments. Combinations of the above embodiments, and other embodiments not specifically described herein, will be apparent to those skilled in the art upon reviewing the above disclosure.

In the foregoing description of the embodiments, various features are grouped together in a single embodiment for the purpose of streamlining the disclosure. This method of disclosure is not to be interpreted as reflecting that the claimed embodiments have more features than are expressly recited in each claim. Rather, as the following claims reflect, inventive subject matter lies in less than all features of a single embodiment. Thus, the following claims are hereby incorporated into the detailed description, with each claim standing on its own as a separate example embodiment.

The abstract is provided to comply with 37 C.F.R. § 1.72(b), which requires an abstract that will allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in a single embodiment for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single embodiment. Thus, the following claims are hereby incorporated into the Detailed Description, with each claim standing on its own as separately claimed subject matter.

Although specific example embodiments have been described, it will be evident that various modifications and changes are made to these embodiments without departing from the broader scope of the inventive subject matter described herein. Accordingly, the specification and drawings are to be regarded in an illustrative rather than a restrictive sense. The accompanying drawings that form a part hereof, show by way of illustration, and without limitation, specific embodiments in which the subject matter are practiced. The embodiments illustrated are described in sufficient detail to enable those skilled in the art to practice the teachings herein. Other embodiments are utilized and derived therefrom, such that structural and logical substitutions and changes are made without departing from the scope of this disclosure. This Detailed Description, therefore, is not to be taken in a limiting sense, and the scope of various embodiments is defined only by the appended claims, along with the full range of equivalents to which such claims are entitled.

Given the teachings provided herein, one of ordinary skill in the art will be able to contemplate other implementations and applications of the techniques of the disclosed embodiments. Although illustrative embodiments have been described herein with reference to the accompanying drawings, it is to be understood that these embodiments are not limited to the disclosed embodiments, and that various other changes and modifications are made therein by one skilled in the art without departing from the scope of the appended claims.

What is claimed is:

1. A method of extending phase linearity associated with a filtering device used with a multilevel digital signal, the method comprising:
configuring a linearized phase filter in accordance with equation (1) as follows
$$H ( s ) = \frac{{\sum }_{n = 1}^{N} {A}_{n} {P}_{n} ( s )}{{\sum }_{m = 1}^{M} {B}_{m} {Q}_{m} ( s )} , \qquad ( 1 )$$
wherein n=1, . . . N, m=1, . . . M, N and M represent maximum terms of the polynomial, N is not equal to M, s=j*ω, ω=2πf, Pₙ and Qₘ represent polynomials, and f represent a normalized frequency of operation, the configuring comprising a synthesis-by-analysis method and an iterative process.

2. The method, as defined by claim 1, wherein the method decreases at least one of rise times and fall times associated with the multilevel digital signal.

3. The method, as defined by claim 1, wherein the method decreases ringing associated with the multilevel digital signal.

4. A linearized phase filter configured to be used with a multilevel digital signal, the linearized phase filter comprising:
a filtering device configured in accordance with equation (1) as follows
$$H ( s ) = \frac{{\sum }_{n = 1}^{N} {A}_{n} {P}_{n} ( s )}{{\sum }_{m = 1}^{M} {B}_{m} {Q}_{m} ( s )} , \qquad ( 1 )$$
wherein n=1, . . . N, m=1, . . . M, N and M represent maximum terms of the polynomial, N is not equal to M, s=j*ω, ω=2πf, Pₙ and Qₘ represent polynomials, and f represent a normalized frequency of operation, the configuration comprising a synthesis-by-analysis method and an iterative process.

5. The linearized phase filter, as defined by claim 4, wherein the filtering device decreases at least one of rise times and fall times associated with the multilevel digital signal.

6. The linearized phase filter, as defined by claim 4, wherein the filtering device decreases ringing associated with the multilevel digital signal.

7. A computer-readable medium comprising instructions that when executed by a processing device performs a method of extending phase linearity associated with a filtering device used with a multilevel digital signal, the method comprising:
configuring a linearized phase filter in accordance with equation (1) as follows
$$H ( s ) = \frac{{\sum }_{n = 1}^{N} {A}_{n} {P}_{n} ( s )}{{\sum }_{m = 1}^{M} {B}_{m} {Q}_{m} ( s )} , \qquad ( 1 )$$
wherein n=1, . . . N, m=1, . . . M, N and M represent maximum terms of the polynomial, N is not equal to M, s=j*ω, ω=2πf, Pₙ and Qₘ represent polynomials, and f represent a normalized frequency of operation, the configuring comprising a synthesis-by-analysis method and an iterative process.

8. The method, as defined by claim 7, wherein the method decreases at least one of rise times and fall times associated with the multilevel digital signal.

9. The method, as defined by claim 7, wherein the method decreases ringing associated with the multilevel digital signal.
